(19) United States
(12) Patent Application Publication
(10) Pub. No.: US 2012/0320837 A1
(43) Pub. Date: Dec. 20, 2012

(54) METHOD FOR ALLOCATING GROUP RESOURCE IN BROADBAND WIRELESS ACCESS SYSTEM

(75) Inventors: Jeong Ki Kim, Anyang-si (KR); Yong Ho Kim, Anyang-si (KR); Young Soo Yuk, Anyang-si (KR)

(73) Assignee: LG Electronics Inc., Seoul (KR)

(21) Appl. No.: 13/510,260

(22) PCT Filed: Nov. 16, 2010
(86) PCT No.: PCT/KR10/08109

§ 371 Date: May 16, 2012

Related U.S. Application Data
(60) Provisional application No. 61/261,677, filed on Nov. 16, 2009.

(30) Foreign Application Priority Data
Apr. 12, 2010 (KR) 10-2010-0033170

(51) Int. Cl. H04W 72/04

(52) U.S. Cl. 370/329

(57) ABSTRACT

A method of transmitting a signal from a base station to a mobile station through Group Resource Allocation (GRA) includes allocating the mobile station to any one of a plurality of groups each including one or more mobile stations, transmitting, to the mobile station, a group configuration message including one or more pieces of burst size information used in the group, to which the mobile station is allocated, and one or more pieces of resource allocation bitmap information which is differently configured according to burst sizes, and transmitting bursts to the mobile station through a resource unit indicated by the resource allocation bitmap.

### TECHNICAL FIELD

The present invention relates to resource allocation between a base station and a mobile station in a broadband wireless access system, and, more particularly, to a method for transmitting group resource allocation information according to group scheduling of a base station to a mobile station.

### BACKGROUND ART

The present invention relates to a broadband wireless access system and, more particularly, to group-based resource allocation control in a mobile communication system.

In a mobile communication system, each base station transmits or receives data to or from a mobile station through one cell/sector in a wireless channel environment. In a system operated using multiple carriers or the like, a base station receives packet traffic from a wired Internet network and transmits the received packet traffic to each mobile station using a predetermined communication protocol. At this time, downlink scheduling includes determination as to when the base station transmits data, to which mobile station the data is transmitted, and which frequency region is used for data transmission. In addition, the base station receives and demodulates data from the mobile station using a predetermined communication protocol and transmits packet traffic through a wired Internet network. On the other hand, uplink scheduling includes determination as to when uplink data is transmitted to the base station, which mobile station transmits the uplink data, and which frequency band is used for uplink data transmission. In general, scheduling is performed such that a mobile station with a good channel status transmits or receives data using more time and frequency resources.

FIG. 1 is a diagram explaining time-frequency resource blocks.

A resource used in communication in a system operated using multiple carriers or the like may be divided into a time domain and a frequency domain. The resource may be defined by Resource Blocks (RBs) and each RB includes N subcarriers and M subframes or a predetermined time unit. At this time, N and M may be 1. One rectangle shown in FIG. 1 denotes one RB, and one RB includes at least one subcarrier located on one axis and a predetermined time unit located on the other axis.

In downlink, the base station selects a mobile station according to a predetermined scheduling rule, allocates one or more RBs to the selected mobile station, and transmits data to the selected mobile station using the allocated RBs. In detail, the base station selects time-frequency RBs with a good channel status based on a downlink Channel Quality Indicator (CQI) reported by the mobile station and transmits data using the selected RBs. Since the time-frequency RBs with the good channel status are used, it is possible to transmit a larger amount of data while using restricted RBs. Thus, it is possible to increase overall data transfer capacity of the system.

In uplink, the base station selects a mobile station and allocates one or more RBs to the selected mobile station according to a predetermined scheduling rule. The mobile station receives scheduling information indicating that the base station has allocated certain RBs to the mobile station and transmits uplink data using the allocated RBs. In detail, a scheduler of the base station may measure the reception status of a pilot signal or a reference signal transmitted from the mobile station and select and allocate time-frequency RBs with a good uplink channel status to the mobile station. The mobile station may transmit uplink data using the allocated RBs.

The scheduling may be performed in group units.

Group Resource Allocation (GRA) technology is a method for allocating resources to a plurality of users belonging to one group in order to reduce overhead for a control message transmitted from a base station to a mobile station. In the case where the GRA technology is used and resources are individually allocated to a plurality of mobile stations, information individually notified to each mobile station, such as resource allocation location information (resource start offset or resource size) and a burst Modulation and Coding Selection (MCS) level, may be compressed and transmitted to each group. Accordingly, it is possible to reduce control information overhead.

FIG. 2 is a diagram showing an example of a GRA method using bitmaps.

Referring to FIG. 2, bitmaps may be used to notify the mobile stations belonging to a predetermined group of resource allocation information. A user bitmap which is a first bitmap indicates which of mobile stations belonging to a specific group corresponding to the bitmap is scheduled at a time corresponding thereto. Each bit of the user bitmap corresponds one-to-one to each of mobile stations belonging to the group. In FIG. 2, one group may include six users at maximum.

Each bit of the user bitmap set to “1” indicates a user (that is, a user, to which resources are allocated) currently scheduled in a frame. FIG. 2(a) shows that first, second, fourth and sixth users are scheduled in an n-th frame (Frame n). Each mobile station may acquire information about its location in a group when being added to the group through a user bitmap received from the base station.

Next, a resource allocation bitmap indicates resource allocation information of the scheduled users and the resource allocation information may include information such as an MCS level and the size of allocated resources. In FIG. 2, since information about one mobile station may be expressed by 3 bits and a total of four mobile stations are scheduled in the n-th frame, the size of the resource allocation bitmap becomes 12 bits (3?4). Since five mobile stations are scheduled in an (n+p)-th frame (Frame n+p), a resource allocation bitmap having a total size of 15 bits is formed.

In the GRA method, the base station first configures a group or additionally allocates one mobile station to the group and determines a Hybrid Automatic Repeat Request (HARQ) burst size set and a resource allocation size set to be used in each group.

In general, when the GRA technology is used, a resource allocation size determined according to a specific burst size is equally applied to several burst sizes used in the group. Accordingly, since the resource allocation size is equally set with respect to all burst sizes used in the group, problems such as MCS use limit and inefficient resource use for each burst size occur.

### DISCLOSURE OF INVENTION

### Technical Problem

An object of the present invention devised to solve the problem lies on a method for configuring a Modulation and Coding Selection (MCS) set capable of efficiently using available resources by flexibly allocating resources to users within a group, and a method for transmitting a signal using the same.

Another object of the present invention devised to solve the problem lies on a method for minimizing a message transmitted to mobile stations included in a group, in order to efficiently use resources when a Group Resource Allocation (GRA) method is used.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### Solution to Problem

The object of the present invention can be achieved by providing a method of transmitting a signal from a base station to a mobile station through Group Resource Allocation (GRA), the method including: transmitting, to the mobile station, a group configuration message for adding the mobile station to a specific group of a plurality of groups each including one or more mobile stations; and receiving an ACK message indicating whether or not the group configuration message is received from the mobile station. At this time, the group configuration message may include at least one of a burst size indicator indicating whether or not a burst size list including one or more pieces of burst size information used in the specific group is included and a resource size indicator indicating whether or not a resource allocation bitmap list including resource allocation information is included.

According to one embodiment of the present invention, if the burst size-list used in the specific group is equal to the burst size list finally applied to the mobile station before the group configuration message is transmitted, the burst size indicator may indicate that the burst size list is not included in the group configuration message.

Alternatively, if the burst size list used in the specific group is not equal to the burst size list finally applied to the mobile station before the group configuration message is transmitted, the burst size indicator may indicate that the burst size list is included in the group configuration message.

According to one embodiment of the present invention, if the resource allocation bitmap list used in the specific group is equal to the resource allocation bitmap list finally applied to the mobile station before the group configuration message is transmitted, the resource size indicator may indicate that the resource allocation bitmap list is not included in the group configuration message.

Alternatively, if the resource allocation bitmap list used in the specific group is not equal to the resource allocation bitmap list finally applied to the mobile station before the group configuration message is transmitted, the resource size indicator may indicate that the resource allocation bitmap list is included in the group configuration message.

At this time, the group configuration message may further include a resource bitmap flag indicating whether or not a resource allocation bitmap corresponding to any one burst size (hereinafter, referred to as an “i-th burst”) of the burst size list is included.

If a resource allocation bitmap for the i-th burst is equal to a resource allocation bitmap for a previously used burst size (hereinafter, referred to as an “(i−1)-th burst”), a field including the resource allocation bitmap list may not include the resource allocation bitmap for the i-th burst.

In contrast, if a resource allocation bitmap for the i-th burst is not equal to a resource allocation bitmap for an (i−1)-th burst, a field including the resource allocation bitmap list may include the resource allocation bitmap for the i-th burst.

According to one embodiment of the present invention, the group configuration message may further include a deletion flag indicating whether or not the mobile station is added to or deleted from the specific group.

The resource allocation bitmap list may include one or more resource allocation bitmaps independently configured with respect to each of one or more bursts.

The group configuration message may include a Medium Access Control (MAC) control message.

The method according to one embodiment of the present invention may further include transmitting a control information map including a group resource allocation message corresponding to the specific group to the mobile station, in order to allocate resources to the mobile station according to the group configuration message, and transmitting the signal to the mobile station through the allocated resources.

In another aspect of the present invention, provided herein is a method of receiving a signal by a mobile station through Group Resource Allocation (GRA), the method including: receiving a group configuration message for adding the mobile station to a specific group of a plurality of groups each including one or more mobile stations from a base station; and transmitting an ACK message indicating whether or not the group configuration message is received to the base station. At this time, the group configuration message may include at least one of a burst size indicator indicating whether or not a burst size list including one or more pieces of burst size information used in the specific group is included and a resource size indicator indicating whether or not a resource allocation bitmap list including resource allocation information is included.

In a further aspect of the present invention, provided herein is a base station using Group Resource Allocation (GRA) including: a transmission module configured to transmit a wireless signal; a reception module configured to receive a wireless signal; and a processor configured to generate a group configuration message including at least one of a burst size indicator indicating whether or not a burst size list used in each of a plurality of groups each including one or more mobile stations is included and a resource size indicator indicating whether or not a resource allocation bitmap list including resource allocation information is included. At this time, the group configuration message may be transmitted through the transmission module, and an ACK message indicating whether or not the group configuration message is received may be received from the mobile station, which receives the group configuration message, through the reception module.

In another aspect of the present invention, provided herein is a mobile station for receiving a signal through Group Resource Allocation (GRA) including: a reception module configured to receive a wireless signal; and a transmission module configured to transmit a wireless signal. At this time, a group configuration message for adding the mobile station to a specific group of a plurality of groups each including one or more mobile stations may be received from a base station through the reception module, an ACK message indicating whether or not the group configuration message is received may be transmitted to the base station through the transmission module.

### Advantageous Effects of Invention

According to the embodiments of the present invention, when resources are allocated in group units, a resource allocation bitmap is differently configured according to burst sizes used by mobile stations belonging to a group. Therefore, it is possible to efficiently apply Modulation and Coding Scheme (MCS) according to the burst sizes.

According to the embodiments of the present invention, it is possible to reduce resource waste generated by applying the same resource allocation bitmap regardless of burst sizes.

According to the embodiments of the present invention, in the case where the same resource allocation bitmap as a previously used burst is applied to a currently used burst among a plurality of bursts used in a group, information about the resource allocation bitmap is not separately included in a group configuration message. Therefore, it is possible to reduce message overhead.

It is to be understood that the advantages that can be obtained by the present invention are not limited to the aforementioned advantages and other advantages which are not mentioned will be apparent from the following description to the person with an ordinary skill in the art to which the present invention pertains.

### BRIEF DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a diagram explaining time-frequency resource blocks;

FIG. 2 is a diagram showing an example of a Group Resource Allocation (GRA) method using bitmaps;

FIG. 3 is a diagram showing an example of a process of transmitting a signal from a base station to a mobile station through general GRA;

FIG. 4 is a diagram showing an example of a process of transmitting a signal from a base station to a mobile station through GRA according to an embodiment of the present invention;

FIG. 5 is a diagram showing another example of a process of transmitting a signal from a base station to a mobile station through GRA according to an embodiment of the present invention;

FIG. 6 is a diagram showing another example of a process of transmitting a signal from a base station to a mobile station through GRA according to an embodiment of the present invention; and

FIG. 7 is a block diagram showing a mobile station and a base station in which the embodiments of the present invention are performed.

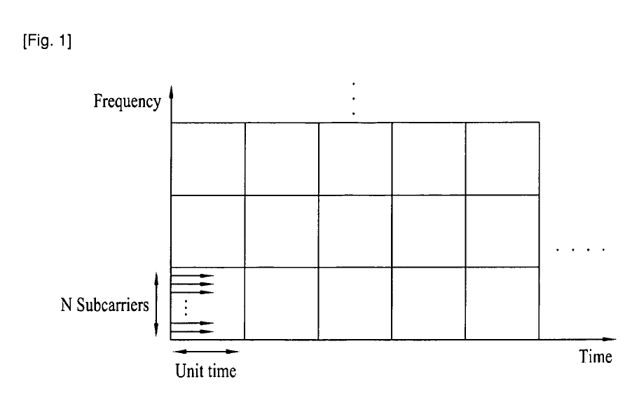

### MODE FOR THE INVENTION

In order to solve the technical problems, the present invention discloses an efficient grouping method, the structure of a group message for delivering group resource allocation information to each group, and a delivery method thereof.

The following embodiments are proposed by combining constituent components and characteristics of the present invention according to a predetermined format. The individual constituent components or characteristics should be considered optional on the condition that there is no additional remark. If required, the individual constituent components or characteristics may not be combined with other components or characteristics. Also, some constituent components and/or characteristics may be combined to implement the embodiments of the present invention. The order of operations to be disclosed in the embodiments of the present invention may be changed to another. Some components or characteristics of any embodiment may also be included in other embodiments, or may be replaced with those of the other embodiments as necessary.

The embodiments of the present invention are disclosed on the basis of a data communication relationship between a base station and a terminal. In this case, the base station is used as a terminal node of a network via which the base station can directly communicate with the mobile station. Specific operations to be conducted by the base station in the present invention may also be conducted by an upper node of the base station as necessary.

In other words, it will be obvious to those skilled in the art that various operations for enabling the base station to communicate with the terminal in a network composed of several network nodes including the base station will be conducted by the base station or other network nodes other than the base station. The term “Base Station” may be replaced with the term fixed station, Node-B, eNode-B (eNB), or access point as necessary. The term “terminal” may also be replaced with the term user equipment (UE), mobile station (MS) or mobile subscriber station (MSS) as necessary.

The following embodiments of the present invention can be implemented by a variety of means, for example, hardware, firmware, software, or a combination thereof.

In the case of implementing the present invention by hardware, the present invention can be implemented with Application Specific Integrated Circuits (ASICs), Digital Signal Processors (DSPs), Digital Signal Processing Devices (DSPDs), Programmable Logic Devices (PLDs), Field Programmable Gate Arrays (FPGAs), a processor, a controller, a microcontroller, a microprocessor, etc.

If operations or functions of the present invention are implemented by firmware or software, the present invention can be implemented in the form of a variety of formats, for example, modules, procedures, functions, etc. The software code may be stored in a memory unit so that it can be driven by a processor. The memory unit is located inside or outside of the processor, so that it can communicate with the aforementioned processor via a variety of well-known parts.

The embodiments of the present invention can be supported by the standard documents disclosed in at least one of wireless access systems, such as an IEEE802 system, a 3rd Generation Partnership Project (3GPP) system, a 3GPP Long Term Evolution (LTE) system, and a 3GPP2 system. That is, the steps or portions, which are not described in order to make the technical spirit of the present invention clear, may be supported by the above documents. In addition, all the terms disclosed in the present document may be described by the above standard documents. In particular, the embodiments of the present invention may be supported by at least one of P802.16-2004, P802.16e-2005 and P802.16Rev2 documents, which are the standard documents of the IEEE 802.16 system.

It should be noted that specific terms disclosed in the present invention are proposed for convenience of description and better understanding of the present invention, and the use of these specific terms may be changed to another format within the technical scope or spirit of the present invention.

In a broadband wireless access system, unicast service control information includes user-specific control information and non-user-specific control information. The user-specific control information may include information for enabling a terminal to decode the user-specific control information, such as the size of the user-specific control information.

The user-specific control information may be composed of control information for one or more users and include resource allocation information, power control information, Hybrid Automatic Repeat reQuest (HARQ) feedback (HARQ ACK/NACK) information, etc. The HARQ ACK/NACK information for uplink data transmission is transmitted through a downlink feedback channel (DL ACK channel) and the downlink feedback channel is distinguished from a control block for other user-specific control information.

In order to allocate resources to a mobile station in group units, group control information may be used. The base station may transmit control information to the mobile station in the form of an A-MAP (Advanced-MAP). The base station may configure multiple information elements configuring user-specific control information for a group including one or more mobile stations, and the user-specific control information may be subjected to separate coding using the identifier of the mobile station or the group.

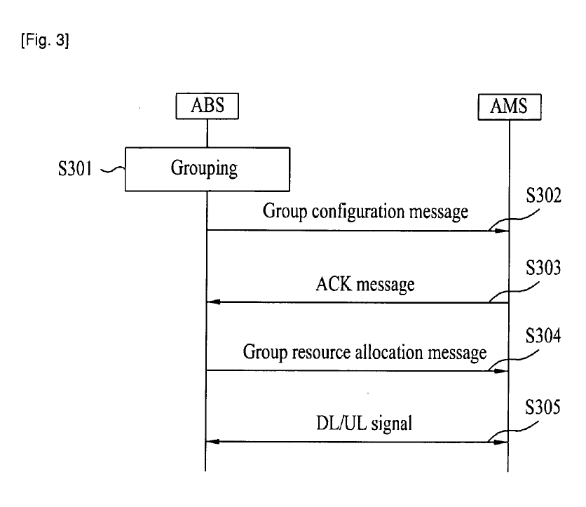

Hereinafter, a group scheduling step for group resource allocation will be briefly described with reference to FIG. 3.

FIG. 3 is a diagram showing an example of a process of transmitting a signal from a base station (Advanced Base Station (ABS)) to a mobile station (Advanced Mobile Station (AMS)) using general Group Resource Allocation (GRA).

Referring to FIG. 3, when the base station decides th use group resource allocation for a flow of an mobile station, the base station performs a grouping operation that adds the flow of the mobile station into an appropriate group among existing groups (S301). IF the existing groups are not appropriate to the flow of the mobile station, the base station may form a new group. For example, mobile stations with the same MCS level may be grouped to form one group. Alternatively, grouping may be performed using a method for adding a new mobile station to a previously formed group or deleting a specific mobile station from the group in downlink or uplink. Each of a plurality of groups generated by grouping uses one Multiple Input Multiple Output (MIMO) mode set and Hybrid Automatic Repeat reQuest (HARQ) burst size set. A plurality of mobile stations belonging to one group may use the MIMO mode set and HARQ burst size set used in the group.

If the group is formed according to the predetermined criterion, the base station transmits a group configuration message to the mobile station in order to add a flow of a mobile station to the group or delete a flow of a mobile station from the current group to which the mobile station belongs (S302).

The group configuration message is a message transmitted for group management when the base station uses group resource allocation in uplink or downlink, and is transmitted in unicast in the form of a group configuration MAC control message. The group configuration message includes the flow identifier (FID) of the added flow, a group identifier (group ID) of the group to which the flow is added or delated, and a assigned User Bitmap Index of a user or a mobile station. Hereinafter, in the specification of the present invention, it is assumed that the base station transmits the group configuration message in order to add the mobile station to a new group.

Hereinafter, the mobile station which receives the group configuration message transmits an ACK message indicating whether or not the group configuration message is received to the base station such that the mobile station is allocated to the group indicated by the group configuration message (S303).

Next, if the mobile station is allocated to a specific group, the base station transmits a group resource allocation message including information about resources allocated to the mobile stations belonging to the group in group units in order to allocate resources in group units (S304). The group resource allocation message is transmitted in the form of a group resource allocation A-MAP IE, and includes bitmap information of mobile stations scheduled to the group through the group configuration message, and information about a MIMO mode, burst sizes and resource allocation sizes used in the group.

Thereafter, the base station may signal transmission/reception with the mobile station through resources allocated to the mobile stations belonging to the group according to the group resource allocation message (S305).

If the group resource allocation technology shown in FIG. 3 is used, the base station determines the size of the resources allocated to the group based on one burst size of the burst size set including a plurality of burst sizes used in the group. Accordingly, the mobile stations allocated to the group use the resources with the same size even when a certain burst size of the burst size set used in the group is used.

Table 1 shows an example of the burst size set used for group resource allocation.

TABLE 1

| Burst Size | |
|---|---|
| (bytes) | Code |
| 6 | 00000 |
| 8 | 00001 |
| 9 | 00010 |
| 10 | 00011 |
| 11 | 00100 |
| 12 | 00101 |
| 13 | 00110 |
| 15 | 00111 |
| 17 | 01000 |
| 19 | 01001 |
| 22 | 01010 |
| 25 | 01011 |
| 27 | 01100 |
| 31 | 01101 |
| 36 | 01110 |
| 40 | 01111 |
| 44 | 10000 |
| 50 | 10001 |
| 57 | 10010 |
| 64 | 10011 |
| 71 | 10100 |
| 80 | 10101 |
| 90 | 10110 |
| 100 | 10111 |
| 114 | 11000 |
| 128 | 11001 |
| 144 | 11010 |
| 164 | 11011 |
| 180 | 11100 |
| 204 | 11101 |
| 232 | 11110 |
| 264 | 11111 |

Referring to Table 1, a total of 32 burst sizes may be used for group resource allocation. While the base station generates the group configuration message in step S302, four burst sizes used in the group in the burst size set including a total of 32 burst sizes shown in Table 1 are selected so as to be included in burst size information for the group.

In addition, the base station may select eight resource allocation sizes from a total of 16 resource allocation sizes with respect to one burst. Upon group resource allocation, the selected eight resource sizes are equally applied to all the burst sizes used in the group.

For example, in the case where the base station selects four burst sizes of 22, 31, 40 and 50 bytes from the burst size set including a total of 32 burst sizes shown in Table 1 as the burst sizes to be used in the group, the resource allocation sizes used in the group may be set to 9, 10, . . . , 16 based on the burst size of 50 bytes according to a resource size inclusion bitmap including resource allocation information.

If it is assumed that the MCSs corresponding to resource allocation sizes are M1, M2, . . . , and M8, the resource allocation sizes corresponding to the MCS sets (M1, M2, . . . , and M8) become 9, 10, . . . , and 16. At this time, the resource allocation sizes corresponding to the MCS sets (M1, M2, . . . , and M8) corresponding to the burst size of 22 bytes may become 4, 5, . . . , and 11. However, in the group resource allocation, since the same resource allocation size is applied to all the burst sizes used in the group, in the case where bursts with the size of 22 bytes are transmitted using M1, the size of the resources allocated to the mobile station by the base station is not 4, but is 9. Therefore, resource waste may occur two times or more.

Accordingly, the present invention proposes a method for variably applying a resource allocation size according to burst sizes used in a group so as to determine an adequate MCS level according to the burst sizes and to efficiently use resources, in the case where group resource allocation technology is used.

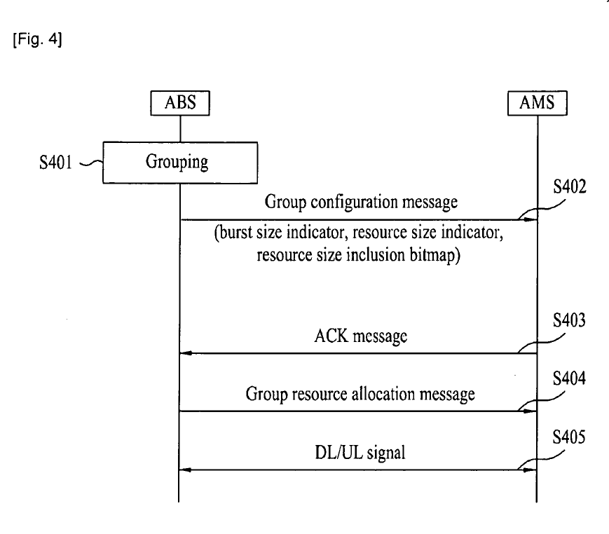

FIG. 4 is a diagram showing an example of a process of transmitting a signal from a base station to a mobile station through GRA according to an embodiment of the present invention.

Referring to FIG. 4, when the base station decides th use group resource allocation for a flow of an mobile station, the base station performs a grouping operation that adds the flow of the mobile station into an appropriate group among existing groups (S401). If the groups are formed, the base station transmits a group configuration message for adding a mobile station to a specific group according to a predetermined criterion (S402). The group configuration message according to one embodiment of the present invention is a group configuration MAC control message transmitted for group management in the case where GRA is used and may be transmitted in a MAC control message format shown in Table 2. The group configuration message according to one embodiment of the present invention may selectively include information about the burst sizes used in the group and resource allocation information, and the resource allocation information may be differently configured according to the burst sizes used in the group. Hereinafter, the group configuration message will be briefly described with reference to Table 2.

TABLE 2

| Syntax | Size(bits) | Description/Notes |
|---|---|---|
| MAC Control | 8 | |
| Message type | | |
| Deletion Flag | 1 | Flag to signal whether this message |
| | | includes addition or deletion |
| | | information. |
| Flow ID | 4 | Identifies the flow that is added |
| | | to group for GRA |
| DL/UL indicator | 1 | 0: DL1: UL |
| If (Deletion Flag == | | |
| 0) { | | |
| Group ID | 5 | ID of the group to which the |
| | | flow is added |
| Long TTI Indicator | 1 | Defines number of subframes |
| | | spanned by the allocated resource. |
| Periodicity | 2 | Periodicity of allocation of this group. |
| MIMO mode set | 2 | Signals the 2-bit MIMO mode set |
| | | corresponding to this group |
| User Bitmap Size | 2 | The size of user bitmap in bits. |
| User Bitmap Index | 5 | Signals index of the flow in group’s |
| | | user bitmap |
| Initial_ACID | 4 | Signals the starting ACID of the range |
| | | of ACIDs assigned to the GRA flow |
| N_ACIDs | 3 | The number of ACIDs assigned |
| | | to the GRA flow |
| Burst Size Indicator | 1 | |
| (b) | | |
| If (b == 1) { | | |
| For (i=1; i<=4; i++) | | |
| { | | |
| Burst size i | 5 | ith burst size of the 4 burst sizes |
| | | supported in the group |
| } | | |
| } | | |
| Resource size | 1 | |
| indicator(r) | | |
| If (r ==1) { | | |
| For | | |
| (i=1; i<=4; i++){ | | |
| Resource size | 16 | -Bitmap to signal which 8 resource |
| inclusion bitmap | | sizes are supported in the group out of |
| | | the range of [1, 16] LRUs supported |
| | | for GRA. |
| } | | |
| } | | |
| } | | |
| Padding | Variable | Padding to align to byte boundary |

Referring to Table 2, the group configuration message format according to one embodiment of the present invention includes a field (deletion flag) including a flag indicating whether a mobile station which receives this message is added to or deleted from a group, a field (flow ID) including an identifier of a service flow added to a group in order to use GRA, and a field (DL/UL indicator) indicating whether a link to which a flow is added is DL or UL.

If the bit of the deletion flag field (deletion flag) indicating whether the mobile station is added to or deleted from the group is set to “0”, it indicates that the group configuration message is transmitted in order to add the mobile station to a certain group, and, in this case, various parameters for adding the mobile station to the group may be included. In contrast, if the bit included in the deletion flag field is set to “1”, it indicates that the group configuration message is transmitted in order to delete the mobile station from a certain group, and, in this case, parameters regarding the group, from which the mobile station is deleted may be included. In the specification of the present invention, the term “flag” is used as the same meaning as an indicator indicating the addition or deletion of specific information.

As shown in Table 2, if the bit of the deletion flag bit is set to “0” in order to indicate the case where the mobile station is added to the group, the group configuration message format includes a field (group ID) including an identifier of a specific group to which the mobile station is added, a Time Transmission Interval (TTI) indicator field (long TTI indicator) including information about the number of subframes connected by allocated resources, a field (periodicity) including allocation period information of the specific group to which the mobile station is added, a field (MIMO mode set) including information about a MIMO mode used in the group, a field (user bitmap size) indicating the size of a user bitmap including information about users belonging to the group, a field (user bitmap index) including an index for identifying the location of each user or mobile station in the group, an initial HARQ channel identifier field (initial_ACID) used in GRA, and a field (N_ACID) indicating the number of ACIDs used in GRA.

In the TTI indicator field (long TTI indicator), a period when a group resource allocation message is transmitted may be specified (for example, in units of 1, 2, 4 and 8 frames). The size (or the length) of the bitmap specified in the user bitmap size field is determined by a maximum number (for example, 4, 8, 16 and 32) of flows supportable by the group, and the size of the bitmap determined with respect to the group is fixed regardless of variation in the number of mobile stations belonging to the group.

In addition, the group configuration message includes a field (burst size indicator) including an indicator indicating whether or not information about the burst sizes used in the group (for example, burst size list information used in the group) is included. The field (burst size indicator) including the burst size indicator includes a bit indicating whether or not information about the burst sizes used in the group to which the mobile station belongs is notified through the group configuration message. In the case where 1 bit is allocated to the burst size indicator field, if the bit is set to “0”, it indicates that the group configuration message does not include the burst size list information and that burst sizes same as last GRA allocation for this flow or mobile satation. IF the bit is set to “1”, it indicates that the group configuration message explicitly includes the burst size list information. Accordingly, as shown in Table 2; if the bit of the field is set to “1”, the group configuration message may further include a field (burst size) including the burst size information. The burst size field includes a burst size list including four pieces of burst size information used in the group and information indicating which burst is used with respect to the mobile station.

Next, the group configuration message includes a field (resource size indicator) including an indicator indicating whether or not information about the size of allocated resource is included. The field including the resource size indicator includes a bit indicating whether or not the size information of resources allocated to the group, to which the mobile station belongs, by the base station is included in the group configuration message. In the case where 1 bit is allocated to the resource size indicator field, if the bit is set to “0”, it indicates that the size information of the resource is not included and, if the bit is set to “1”, it indicates that the size information of the resources is included. Accordingly, as shown in Table 2, if the bit of the field is set to “1”, the group configuration message further includes a field including a resource size inclusion bitmap (hereinafter, referred to as a “resource allocation bitmap”) indicating resource allocation information, and resource allocation bitmap list information may be delivered through this field.

At this time, the base station according to one embodiment of the present invention may differently determine the resource allocation size according to burst sizes in the burst size list used in one group. The base station may use one Logical Resource Unit (LRU) to 16 LRUs as one resource allocation size while performing GRA, and select 8 resource sizes as the resource sizes allocated to one group. For example, in the case where 16 bits are allocated as the resource allocation bitmap, each bit indicates the size of the resources corresponding thereto. Accordingly, if an n-th bit is set to 1 in the resource allocation bitmap, it is indicated that n LRUs are set as one resource allocation size with respect to the group. Since the base station may select 8 resource allocation sizes with respect to one group, 8 bits may be set to 1 and the remaining bits may be set to 0 in the bitmap.

Accordingly, the number of resource allocation bitmaps is determined according to the number of the burst sizes used in the group, and the resource allocation bitmaps may be differently configured. For example, in the case where the base station uses four burst sizes with respect to each group, four or less independent resource allocation bitmaps may be configured.

The field including the resource allocation bitmap information includes a resource allocation bitmap list used for the group and a resource allocation bitmap corresponding to the burst size indicated in the burst size field.

Table 3 shows an example of converting the group configuration message according to one embodiment of the present invention shown in Table 2 into an ASN.1 form.

TABLE 3
-- Group Configuration MessageAAI-GRP-CFG ::= SEQUENCE {

messageType OCTET STRING (SIZE(1)), --

identify the flow to be added or deletedflowId
INTEGER (0..15), -- present when a flow is added to a
GRA graInfoForAddedFlow GroupRsrcAllocInfo OPTIONAL }
GroupRsrcAllocInfo ::= SEQUENCE { -- Signals the starting ACID
of the range of ACIDs assigned to the -- GRA flow

initialAcid INTEGER (0..15), -- The

number of ACIDs assigned to the GRA
flow numberOfAcid INTEGER (0..7),

burstSizeList BurstSizeList

OPTIONAL, resourceBitmapList ResourceBitmapList
OPTIONAL } BurstSizeList ::= SEQUENCE (SIZE
(1..4)) OF INTEGER (0..31) ResourceBitmapList ::= SEQUENCE (SIZE
(1..4)) OF BIT STRING (SIZE(16))

In the message shown in Table 3, for simplification of the specification, although some information corresponding to the fields described with reference to Table 2 is omitted, the group configuration message according to one embodiment of the present invention may further include information omitted from Table 3.

In Table 3, “graInfoForAddedFlow”, “BurstSizeList” and “ResourceBitmapList” are selectively included in the group configuration message.

Information corresponding to “graInfoForAddedFlow” is selectively included in the group configuration message in the case where a new mobile station is added to a certain group. Accordingly, if a certain mobile station is deleted from the group, the field corresponding to “graInfoForAddedFlow” is not included in the group configuration message.

Information corresponding to “BurstSizeList” is burst size list information including all burst sizes used in the group and includes four sequences if four burst sizes are used in the group. In the case where the base station changes the group, to which the mobile station belongs, from a first group to a second group, the “BurstSizeList” field may be selectively included in the group configuration message, depending on whether or not burst size list information used in the first group and burst size list information used in the second group are identical. In detail, if the burst size information used in the groups before and after change is the same, the same burst size information may be omitted so as to reduce the amount of information included in the group configuration message.

That is, if the burst size lists are the same, in the group configuration message format shown in Table 2, the bit of the field (burst size indicator) indicating whether or not the burst size information is included is set to “0” and the field (burst size) including the information about the burst size need not be separately configured.

Next, information corresponding to “ResourceBitmapList” includes a resource bitmap list including all resource allocation bitmap information used in the group. According to the above-described embodiment, if four burst sizes are used in each group, the number of resource allocation bitmaps determined according to the burst sizes may be four. Accordingly, four sequences corresponding to the resource allocation bitmaps are included. For example, in the case where the base station changes the group, to which the mobile station belongs, from the first group to the second group, the “ResourceBitmapList” field may be selectively included in the group configuration message depending on whether or not bitmap information used in both groups is the same. That is, in the case where the applied resource allocation information is the same although the group of the mobile station is changed, the resource allocation information is not retransmitted so as to reduce the amount of information included in the group configuration message. Accordingly, in the case where the resource bitmap lists applied to the mobile station are the same even when the group of the mobile station is changed, in Table 2, the field (resource size indicator) indicating whether or not the resource size information is included is set to “0” and the field (resource size inclusion bitmap) including the resource bitmap information need not be separately configured.

Referring to FIG. 4 again, the mobile station which receives the group configuration message having the format shown in Table 2 transmits an ACK message indicating whether or not the group configuration message is received to the base station such that the mobile station is allocated to a specific group indicated in the group configuration message (S403). Accordingly, the mobile station uses the MIMO mode, the burst sizes and the resource allocation sizes used in the group.

Next, the base station transmits a group resource allocation message to the mobile station in order to perform an operation for allocating resources to mobile stations belonging to one group in group units (S404). At this time, the group resource allocation message may be transmitted in the form of a Group Resource Allocation A-MAP Information Element (GRA A-MAP IE) as described with reference to FIG. 3.

Table 4 shows an example of a group resource allocation message format associated with one embodiment of the present invention.

TABLE 4

| | Size in | |
|---|---|---|
| Syntax | bits* | Description/Notes |
| Group Resource Al- | — | — |
| location A-MAP_IE( ) | | |
| { | | |
| A-MAP IE Type | 4 | Group Resource Allocation A-MAP IE |
| User Bitmap | Variable | Bitmap to indicate scheduled |
| | | AMSs in a group. |
| Resource Offset | 7 | Indicates starting LRU for |
| | | resource assignment to this group |
| HFA Offset | 6 | Indicates the start of HARQ Feedback |
| | | index used for scheduled allocations. |
| If( Group MIMO | | |
| mode set ==0b01){ | | |
| MIMO Bitmap | Variable | Bitmap to indicate MIMO mode for the |
| | | scheduled AMSs. |
| } | | |
| Resource Assignment | Variable | Bitmap to indicate burst size/ |
| Bitmap | | resource size for each scheduled AMS |
| } | — | — |

Referring to Table 4, the group resource allocation message includes a field (A-MAP IE Type) indicating the type of the A-MAP IE, a bitmap field (User Bitmap) indicating a plurality of mobile stations scheduled in the group, a field (Resource Offset) indicating a starting location for allocating resources to the group is allocated, a field (HFA Offset) indicating the start of a HARQ feedback index used for resource allocation scheduling, a field (MIMO Bitmap) indicating a MIMO mode used by mobile stations scheduled in the group, and a field (Resource Assignment Bitmap) including a bitmap including a burst size used in each mobile station scheduled in the group and information indicating resource allocation size.

The size of the bitmap included in the user bitmap field (User Bitmap) is determined according to the size information of the user bitmap included in the group configuration message transmitted in step S402. The bit of the user bitmap field set to “0” indicates that the mobile station which receives it is not allocated in a current Advanced Air Interface (AAI) subframe and the bit of user bitmap field set to “1” indicates that the mobile station is allocated in the current AAI subframe.

The resource allocation bitmap field includes a bitmap indicating burst size information of each mobile station scheduled in the group and resource allocation size information. The resource allocation bitmap may use 5 bits with respect to each mobile station in order to signal the HARQ burst size and the resource allocation size to the mobile station. The first two bits of 5 bits indicate the burst size information, three consecutive bits indicate resource sizes, each of which may be determined according to the information included in the group configuration message transmitted in step S402.

The base station which transmits the group resource allocation message for GRA may perform signal transmission or reception with the mobile station using the resource sizes allocated according to the group configuration message and the group resource allocation message (S405).

According to one embodiment of the present invention, in the case where GRA is used, the base station can reduce the amount of information included in the group configuration message to be transmitted so as to reduce resources necessary for message transmission and perform efficient message transmission. In addition, the base station may differently determine the resource allocation size in the case where different burst sizes are used according to the mobile stations even when the mobile stations belong to the same group, and, as a result, may flexibly apply an MCS set to the transmitted signal. That is, according to one embodiment of the present invention, the MCS set may be configured in consideration of both the burst sizes and the resource allocation sizes.

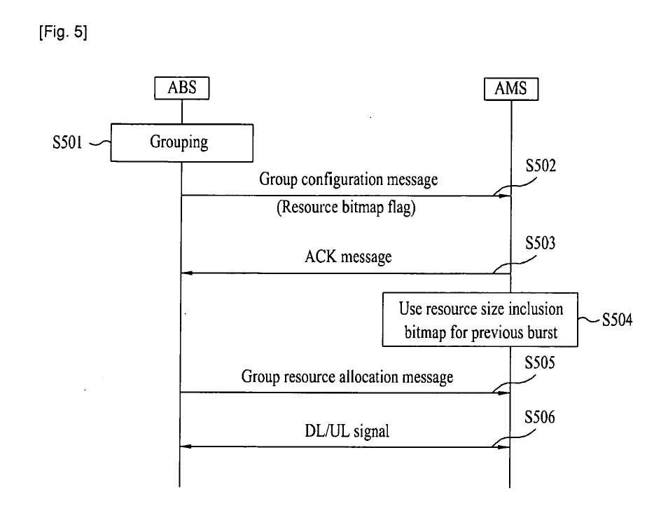

FIG. 5 is a diagram showing another example of a process of transmitting a signal from a base station to a mobile station through GRA according to an embodiment of the present invention.

Referring to FIG. 5, the base station performs a grouping operation for forming a plurality of groups each including one or more mobile stations according to a predetermined criterion in order to allocate resources in group units (S501). Similarly to the above-described embodiment, if the groups are formed according to the predetermined criterion, the base station transmits a group configuration message including information about the group, to which the mobile station belongs, to the mobile station (S502). At this time, if it is assumed that the base station includes the burst size list information and the resource bitmap list information used in the group in the group configuration message, the group configuration message according to another embodiment of the present invention may selectively include a resource allocation bitmap for a specific burst size to be used currently in the resource bitmap list information. That is, the number of resource allocation bitmaps included in the group configuration message may not be equal to the number of burst sizes used in the group. For example, if the resource allocation information corresponding to the burst size to be currently used in the mobile station and the resource allocation information for the burst size used previously are equal in the group, the group configuration message may be configured in a state in which the resource allocation bitmap for the current burst size is omitted.

Table 5 shows another example of a group configuration MAC control message format according to one embodiment of the present invention.

TABLE 5

| | Size | |
|---|---|---|
| Syntax | inbits* | Description/Notes |
| . . . | . . . | . . . |
| Resource size | 1 | |
| indicator (r) | | |
| If (r == 1) { | | |
| For (i=1; i<=4; | | |
| i++) { | | |
| skip | 1 | If the bitmap for the next burst size is the |
| | | same as the previous one, this bit is set to 1. |
| If (skip ==0) { | | |
| Resource size | 16 | -Bitmap to signal which 8 resource sizes are |
| inclusion bitmap | | supported in the group out of the range |
| | | of [1, 16] LRUs supported for GRA. |
| } | | |
| } | | |
| } | | |
| } | | |
| Padding | Variable | Padding to align to byte boundary |

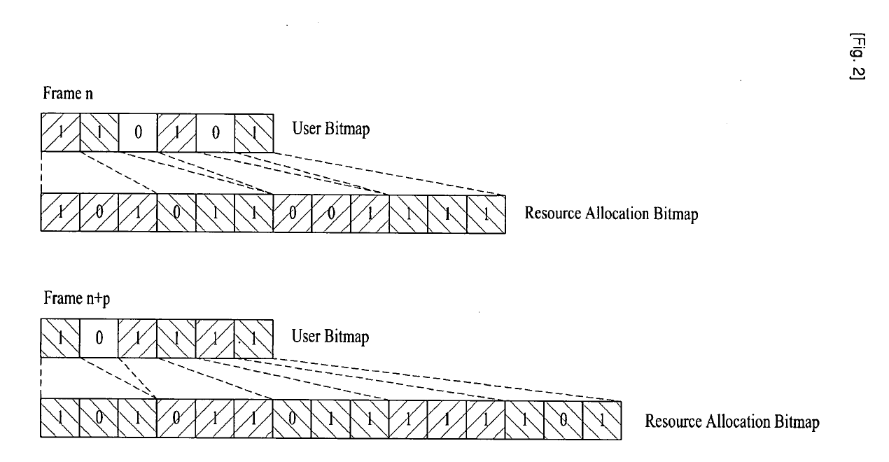

In Table 5, for simplification of description, although the same fields as the group configuration message according to one embodiment of the present invention described with reference to FIG. 2 are omitted, the group configuration message may further include the omitted fields.

Referring to Table 5, in the group configuration message according to one embodiment of the present invention, a “skip” field is added to the field including the resource allocation information so as to indicate whether or not resource allocation information bitmap information for a currently used i-th burst size is included.

For example, as shown in Table 5, in the case where 1 bit is allocated to the “skip” field, if the bit set is to “1”, it is indicated that separate bitmap information is not transmitted because the resource allocation bitmap for the i-th burst size is equal to the resource allocation bitmap for an (i−1)-th burst size, and, if the bit is set to “0”, it indicates that newly defined resource allocation bitmap information for the i-th burst size is transmitted because the resource allocation bitmap for the i-th burst size is different from the resource allocation bitmap for the (i−1)-th burst size. The “skip” field may indicate whether or not the resource allocation bitmap for the i-th burst size is included, using a resource bitmap flag, and may be referred to as a resource bitmap flag field.

The information indicated in the “skip” field shown in Table 5 may be changed according to bit configuration, and the number of bits allocated to the field may be increased so as to include more detailed information. In the group configuration message shown in Table 5, since the bit of the “skip” field is set to “0”, the bitmap size inclusion bitmap field indicating information about the resource size inclusion bitmap is included.

Table 6 shows an example of converting the group configuration message according to another embodiment of the present invention shown in Table 5 into an ASN.1 form.

TABLE 6
GroupRsrcAllocInfo ::= SEQUENCE { -- Signals the starting ACID
of the range of ACIDs assigned to the -- GRA flow

initialAcid INTEGER (0..15), -- The

number of ACIDs assigned to the GRA
flow numberOfAcid INTEGER (0..7),

burstSizeList BurstSizeList

OPTIONAL, resourceBitmapList ResourceBitmapList
OPTIONAL } BurstSizeList ::= SEQUENCE (SIZE
(1..4)) OF INTEGER (0..31) ResourceBitmapList ::= SEQUENCE (SIZE
(1..4)) OF BIT STRING (SIZE(16)) ResourceBitmapList ::= SEQUENCE
(SIZE (1..4)) OF Re-sourceBitmap ResourceBitmap::= SEQUENCE
{ resourceInclusionBitmap BIT STRING

| | |
|---|---|
| { | b0 (0), |
| | b1 (1), |
| | b2 (2), |
| | b3 (3), |
| | b4 (4), |
| | b5 (5), |
| | b6 (6), |
| | b7 (7), |
| | b8 (8), |
| | b9 (9), |
| | b10 (10), |
| | b11 |

| | |
|---|---|
| (11), | b12 |
| (12), | b13 |
| (13), | b14 |
| (14), | b15 (15)} (SIZE(16)) |

OPTIONAL}

In Table 6, “graInfoForAddedFlow”, “burstSizeList”, “resourceBitmapList” and “resourcelnclusionBitmap” fields are selectively included in the group configuration message.

The conditions including fields corresponding to “graInfoForAddedFlow”, “burstSizeList” and “resourceBitmapList” are described above with reference to Table 3 and thus a description thereof will be omitted.

Information corresponding to “resourcelnclusionBitmap” is resource allocation bitmap information applied to each burst size used in the mobile station and may be selectively included in the group configuration message in the case where “resourceBitmapList” is included. As described above, when the group of the mobile station is changed or the mobile station is added to a new group, in the case where the resource allocation bitmap list is included because a previously allocated resource allocation bitmap is not equal to a resource allocation bitmap of the group to which the mobile station currently belongs and a resource allocation bitmap for an i-th burst size is equal to a bitmap for an (i−1)-th burst size in the included list, the “resourcelnclusionBitmap” information may be omitted. Accordingly, if both bitmaps are the same, as shown in Table 5, the bit of the “skip” field is set to “1” so as to indicate that the “resourcelnclusionBitmap” information is not included.

Referring to FIG. 5 again, the mobile station which receives the group configuration message transmits an ACK message indicating whether or not the group configuration message is received to the base station such that the mobile station is added to the group and GRA is available (S503).

At this time, the mobile station may determine that the resource size information inclusion bitmap for the i-th burst to be currently used in the base station is equal to the resource size information inclusion bitmap configured for the (i−1)-th burst, if the bit of the “skip” field included in the group configuration message is set to “1” (S504). That is, the mobile station may use the bitmap information acquired in a previous burst transmission/reception process for sequential burst.

Thereafter, the base station transmits a group resource allocation message including associated information to the mobile station in order to allocate resources to the mobile station (S505). At this time, burst size information and resource allocation size information included in the group resource allocation message may be determined according to the information included in the group configuration message transmitted in step S502.

After the group resource allocation message is transmitted, the base station and the mobile station may transmit or receive a signal through resources allocated according to the group configuration message and the group resource allocation message (S506). Similarly, the MCS may be applied according to the burst size corresponding to the signal to be transmitted from the MCS set determined in consideration of both the burst sizes and the resource allocation sizes when transmitting or receiving the signal.

In the embodiments of the present invention described with reference to FIGS. 4 and 5, even when the resource allocation sizes are differently determined according to the burst sizes, the sizes of the resource allocation bitmaps for transmitting the resource allocation information are equally set to 16 bits.

In another embodiment of the present invention, the sizes of the resource allocation bitmaps as well as the resource allocation sizes for a plurality of burst sizes used in one group are differently configured.

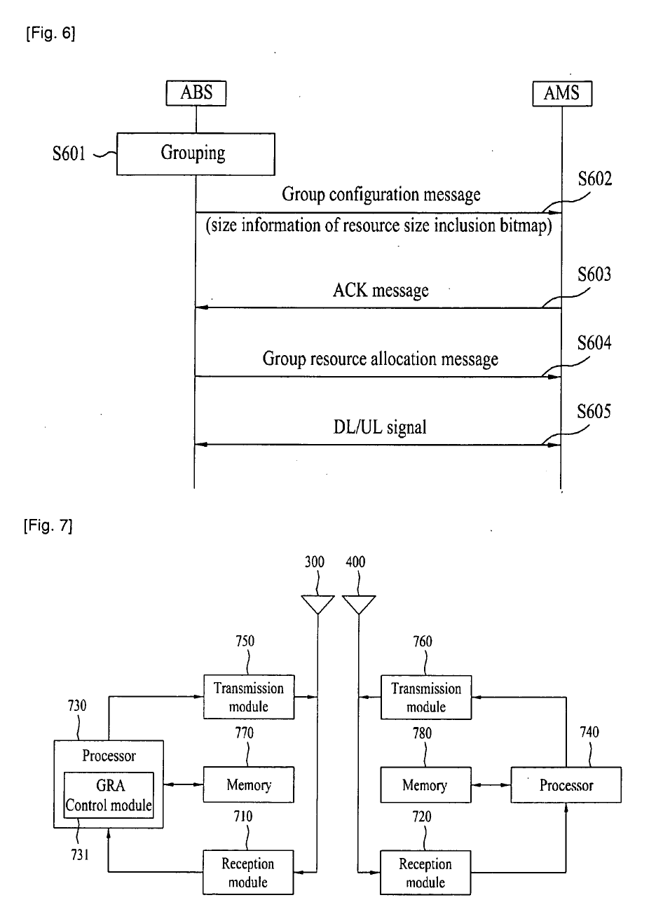

FIG. 6 is a diagram showing another example of a process of transmitting a signal from a base station to a mobile station through GRA according to an embodiment of the present invention.

Referring to FIG. 6, the base station performs a grouping operation for forming a plurality of groups according to a predetermined criterion, similarly to the above-described embodiment (S601). The base station transmits a group configuration message including information about a specific group associated with the mobile station in order to use GRA (S602). Similarly, it is assumed that the mobile station is added to the specific group. At this time, the base station may differently configure the sizes of the resource allocation bitmaps according to the burst sizes used in the group.

Table 7 shows another example of a group configuration MAC control message format according to one embodiment of the present invention.

TABLE 7

| Syntax | Size inbits* | Description/Notes |
|---|---|---|
| . . . | . . . | . . . |
| Resource size indicator | 1 | |
| (r) | | |
| If (r == 1) { | | |
| For (i=1; i<=4; i++) { | | |
| Size of Bitmap | 2 | Size of resource size inclusion bitmap de- |
| | | termined according to burst sizes0b00: The bitmap |
| | | for this burst size is the same as the |
| | | previous one0b01: Bitmap size is 80b10: |
| | | Bitmap size is 160b11: Bitmap size is 32 |
| If(Size of Bitmap != | | |
| 0b00){ | | |
| Resource size inclusion | Variable[8][16] | -Bitmap to signal which 8 resource sizes are |
| bitmap | [32] | supported in the group out of the range of [1, 16] |
| | | LRUs supported for GRA. |
| | | -Bitmap including resource |
| | | allocation size information variably |
| | | applied to each burst size |
| } | | |
| } | | |
| } | | |
| } | | |
| Padding | Variable | Padding to align to byte boundary |

Referring to Table 7, the group configuration message according to one embodiment of the present invention may include a bitmap size field (Size of Bitmap) including information about the size of the resource allocation bitmap flexibly determined according to the burst sizes. In the present invention, the size of the resource allocation bitmap is set to any one of 8, 16 and 32 according to the burst sizes. For example, in the case where two bits are allocated to the field, if the bit is set to “00”, it is indicated that the size of the resource allocation bitmap for the i-th burst size to be transmitted currently is equal to the size of the resource allocation bitmap for the (i−1)-th burst size. In this case, if the sizes of the resource allocation bitmaps for both burst sizes and the resource allocation information indicated by the bitmaps are the same, the field (Resource size inclusion bitmap) including the resource allocation bitmap information may not be separately configured. That is, since the mobile station can derive the information about the currently used burst size from the bitmap for the previously used burst size, it is possible to prevent information from being repeatedly transmitted.

If the bit is set to “01”, it indicates that the size of the resource allocation bitmap is 8 bits, if the bit is set to “10”, it indicates that the size of the resource allocation bitmap is 16 bits, and, if the bit is set to “11”, it indicates that the size of the resource allocation bitmap is 32 bits. However, the information indicated according to the bit configuration of the bitmap size field is only shown for the purpose of illustrating the present invention, and information to be delivered may be changed according to a bit configuration value and the number of bits allocated to the field may be increased so as to include more detailed information. In the group configuration message shown in Table 7, since the bits of the bitmap size field are set to “00”, it indicates that the size of the resource allocation bitmap for the previously transmitted (i−1)-th burst size is used without change.

Next, a field (Resource size inclusion bitmap) including the resource allocation bitmap includes information about the resource allocation size used for the bursts through the resource size inclusion bitmap, the size of which is differently configured according to burst sizes. The size of the resource allocation bitmap is determined according to the bitmap size indicated by the bitmap size field such that any one of 8, 16 and 32 bits is allocated to the resource size inclusion bitmap field.

Accordingly, if each of 8, 16 and 32 bits is allocated to the field, information about 4, 8 and 16 resource sizes selected with respect to the bursts can be signaled through a bitmap in the range of 8, 16 and 32 LRUs used in GRA. Alternatively, a bitmap may be configured so as to select four or eight resource sizes with respect to one burst size regardless of the size of the bitmap.

Table 8 shows another example of a MAC control message format and, more particularly, another example of a group configuration message format according to one embodiment of the present invention.

TABLE 8

GroupRsrcAllocInfo ::= SEQUENCE { -- Signals the starting ACID

of the range of ACIDs assigned to the -- GRA flow

initialAcid INTEGER (0..15), -- The

number of ACIDs assigned to the GRA
flow numberOfAcid INTEGER (0..7),

burstSizeList BurstSizeList

OPTIONAL, resourceBitmapList ResourceBitmapList
OPTIONAL } BurstSizeList ::= SEQUENCE (SIZE
(1..4)) OF INTEGER (0..31) ResourceBitmapList ::= SEQUENCE (SIZE
(1..4)) OF BIT STRING (SIZE(16)) ResourceBitmapList ::= SEQUENCE
(SIZE (1..4)) OF Re-sourceBitmap ResourceBitmap::= SEQUENCE
{ resourceInclusionBitmap OCTET STRING (SIZE(1..4))
OPTIONAL}

In table 8, “graInfoForAddedFlow”, “burstSizeList” and “resourceBitmapList” fields are selectively included in the group configuration message and the conditions including the fields are described with reference to Table 3, and a description thereof will be omitted.

In addition, the “resourceInclusionBitmap” field may be selectively included, depending on whether or not the bitmap sizes and the resource allocation information for the burst sizes used in the group are identical.

Referring to FIG. 6 again, the mobile station transmits an ACK message indicating whether or not the group configuration message is received to the base station such that the mobile station is added to a specific group indicated by the group configuration message (S603).

Hereafter, the base station transmits a group resource allocation message including associated information to the mobile station in order to allocate resources to the mobile station (S604). At this time, burst size information and resource allocation size information included in the group resource allocation message may be determined according to the information included in the group configuration message transmitted in step S602.

After the group resource allocation message is transmitted, the base station and the mobile station may transmit or receive a signal through resources allocated according to the group configuration message and the group resource allocation message (S605). Similarly, the MCS may be applied according to the burst size corresponding to the signal to be transmitted from the MCS set determined in consideration of both the burst sizes and the resource allocation sizes when transmitting or receiving the signal.

According to the embodiments of the present invention, different resource size inclusion bitmaps are applied according to the burst sizes used in GRA such that resource waste generated when a fixed resource size inclusion bitmap is used is reduced and an adequate MCS set is applicable in consideration of both the burst sizes and the resource allocation sizes. In addition, when the same resource size inclusion bitmap information as previously transmitted bursts is applied to current bursts, the base station configures the group configuration message in a state of omitting the same bitmap-associated information so as to reduce message overhead.

Next, FIG. 7 is a block diagram showing a mobile station and a base station in which the embodiments of the present invention are performed.

The mobile station may operate as a transmitter in uplink and operate as a receiver in downlink. In addition, the base station may operate as a receiver in uplink and operate as a transmitter in downlink. That is, the mobile station and the base station may include a transmitter and a receiver for data or information transmission.

Each of the transmitter and the receiver may include processors, modules, parts and/or means for performing the embodiments of the present invention. In particular, each of the transmitter and the receiver may include a module (means) for encrypting a message, a module for analyzing the encrypted message, an antenna for transmitting or receiving the message, and the like.

Referring to FIG. 7, a left side shows the structure of the transmitter and a right side shows the structure of the receiver. The transmitter and the receiver may include reception modules 710 and 720, processors 730 and 740, transmission modules 750 and 760 and memories 770 and 780, respectively.

The antenna includes a reception antenna for receiving wireless signals from external devices and sending the wireless signals to the reception modules 710 and 720 and a transmission antenna for transmitting signals generated by the transmission modules 750 and 760 to external devices. The number of antennas may be two or more if a Multiple Input Multiple Output (MIMO) function is supported.

The reception modules 710 and 720 perform decoding and demodulation with respect to the wireless signals received from the external devices through the antennas, restore original data, and send the original data to the processors 730 and 740. The reception module and the antenna may be represented by a reception unit, for receiving wireless signals, unlike FIG. 7.

The processors 730 and 740 generally control the overall operation of the transmitter or the receiver. In particular, a controller function for performing the embodiments of the present invention, a Medium Access Control (MAC) frame variable control function according to service characteristics and a propagation environment, a handover function, an authentication and encryption function and the like may be performed.

The transmission modules 750 and 760 may perform predetermined coding and modulation with respect to data which is scheduled from the processors 730 and 740 to be transmitted to the external devices and send the data to the antennas. The transmission module and the antenna may be represented by a transmission unit for transmitting wireless signals, unlike FIG. 7.

The memories 770 and 780 may store programs for processing and controlling the processors 730 and 740 and perform a function for temporarily storing input/output data (uplink grant, system information, station identifier (STID), flow identifier (FID), operation time, and the like allocated from the base station, in the case of the mobile station). In addition, the memories 770 and 780 may include at least one of a flash memory type, hard disk type, multimedia card micro type, or card type memory (for example, an SD or XD memory or the like), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, an optical disk, and the like.

The processor 730 of the transmitter may include a GRA control module 731 for performing the overall control operation of the base station, performing grouping such as addition or deletion of the mobile station, which is the receiver, to or from a specific group, and allocating resources to the group including the receiver in group units.

The GRA module may perform GRA according to the embodiments of the present invention in association with FIGS. 4 to 6 and generate a group configuration message and a group resource allocation message in order to transmit information about the GRA to the receiver. At this time, the GRA control module 321 may determine whether or not burst size list information, resource bitmap list information and resource allocation bitmap information for each burst size are transmitted to the mobile station, and configure the group configuration message.

The receiver receives the group configuration message and the group resource allocation message transmitted from the transmitter through the reception module 720 and acquires the burst size information, the resource allocation information, and resource allocation information, which is differently configured according to the burst sizes, for the group to which the receiver belongs.

The processor 740 of the receiver performs the overall control operation of the mobile station and performs the overall operation necessary to perform communication such as synchronization with the base station based on the received broadcast information. In addition, the processor 740 may store a burst size list and resource bitmap list information included in the group configuration message received through the reception module 720 in the memory 780. If the group of the receiver is changed or if the burst size information or the resource allocation information used in a newly added group is the same, the information may be retrieved from the memory 780.

The base station may perform a controller function for performing the embodiments of the present invention, Orthogonal Frequency Division Multiple Access (OFDMA) packet scheduling, Time Division Duplex (TDD) packet scheduling and channel multiplexing function, a MAC frame variable control function according to service characteristics and propagation environments, a high-speed traffic real-time control function, a handover function, and an authentication and encryption function, a packet modulation/demodulation function for data transmission, a real-time modem control function and the like through at least one of the above-described modules, or may further include separate means, modules, parts or the like for performing such functions.

### INDUSTRIAL APPLICABILITY

The embodiments of the present invention can be applied to various wireless access systems. Examples of various wireless access systems include 3GPP (3rd Generation Partnership Project) system, 3GPP2 system and/or IEEE 802.xx (Institute of Electrical and Electronic Engineers 802) system. The embodiments of the present invention can be applied to all technical fields to which the various access systems are applied, as well as the various access systems.

1-26. (canceled)

27. A method of transmitting a signal from a base station to a mobile station through Group Resource Allocation (GRA), the method comprising:
transmitting a group configuration message for adding a first flow of the mobile station to a first group of a plurality of groups to the mobile station, each of the plurality of groups including one or more flows; and
receiving an ACK message indicating a successful acknowledgement of the group configuration message from the mobile station,
wherein the group configuration message includes burst size information indicating at least one burst size of a plurality of burst sizes supported for the first flow if a plurality of burst sizes previously used are changed.

28. The method according to claim 27, wherein the group configuration message further includes a flag indicating whether the first flow of the mobile station is added to or deleted from the first group.

29. The method according to claim 27, wherein the group configuration message further includes a resource allocation bitmap indicating at least one resource size supported for the first group.

30. The method according to claim 27, wherein the group configuration message includes a Medium Access Control (MAC) control message.

31. The method according to claim 27, further comprising:
transmitting a control information map including a group resource allocation message corresponding to the first group to the mobile station, in order to allocate resources for the first flow of the mobile station according to the group configuration message; and
transmitting the signal to the mobile station through the allocated resources.

32. A method of receiving a signal by a mobile station through Group Resource Allocation (GRA), the method comprising:
receiving a group configuration message for adding a first flow of the mobile station to a first group of a plurality of groups from a base station, each of the plurality of groups including one or more flows; and
transmitting an ACK message indicating a successful acknowledgement of the group configuration message to the base station,
wherein the group configuration message includes burst size information indicating at least one burst size of a plurality of burst sizes supported for the first flow if a plurality of burst sizes previously used are changed.

33. The method according to claim 32, wherein the group configuration message further includes a flag indicating whether the first flow of the mobile station is added to or deleted from the first group.

34. The method according to claim 32, wherein the group configuration message further includes a resource allocation bitmap indicating at least one resource size supported for the first group.

35. The method according to claim 32, wherein the group configuration message includes a Medium Access Control (MAC) control message.

36. The method according to claim 32, further comprising:
receiving a control information map including a group resource allocation message corresponding to the first group from the base station; and
receiving the signal from the base station through the allocated resources,
wherein the group resource allocation message includes resource allocation information allocated according to the group configuration message.

37. A mobile station for receiving a signal through Group Resource Allocation (GRA), the mobile station comprising:
a reception module configured to receive a group configuration message for adding a first flow of the mobile station to a first group of a plurality of groups from a base station, each of the plurality of groups including one or more flows; and
a transmission module configured to transmit an ACK message indicating a successful acknowledgement of the group configuration message to the base station,
wherein the group configuration message includes burst size information indicating at least one burst size of a plurality of burst sizes supported for the first flow if a plurality of burst sizes previously used are changed.

38. The mobile station according to claim 37, wherein the group configuration message further includes a flag indicating whether the first flow of the mobile station is added to or deleted from the first group.

39. The mobile station according to claim 37, wherein the group configuration message further includes a resource allocation bitmap indicating at least one resource size supported for the first group.

40. The mobile station according to claim 37, wherein the group configuration message includes a Medium Access Control (MAC) control message.

41. The mobile station according to claim 37, wherein the reception module further receives a control information map including a group resource allocation message corresponding to the first group from the base station,
wherein the reception module further receives the signal from the base station through the allocated resources, and
wherein the group resource allocation message includes resource allocation information allocated according to the group configuration message.
